(19) United States
(12) Patent Application Publication
(10) Pub. No.: US 2020/0282404 A1
(43) Pub. Date: Sep. 10, 2020

(54) HELICAL GEAR WELL FOR CRUSHING APPARATUS

(71) Applicant: FLSmidth A/S, Valby (DK)

(72) Inventors: Daniel Svensson, Sandy, UT (US); Mark Daniel, West Jordan, UT (US); Mats Olof Lindqvist, Blatungavagen (SE); Nathan Lewis Miller, Salt Lake City, UT (US)

(21) Appl. No.: 16/764,534

(22) PCT Filed: Nov. 16, 2018
(86) PCT No.: PCT/IB2018/059070

§ 371 Date: May 15, 2020

(30) Foreign Application Priority Data
Nov. 16, 2017 (DK) PA 2017 70866

(51) Int. Cl. B02C 2/04; B02C 23/00

(52) U.S. Cl. CPC B02C 2/04; B02C 23/00

(57) ABSTRACT

A novel gear well (200) for a crusher (1) may be characterized in that the recess (210) comprises a helical, non-uniform depth recess having a high point (212A) and a low point (212B). The gear well (200) may be further characterized in that rather than extending to a sharp corner transition (112) and then to an orthogonal sidewall (126), the floor (211) of the recess (210) may instead intersect or blend with the pinion clearance floor (222) adjacent the low point (212B). The helical, non-uniform depth recess (210) is preferably configured for improving the strength of a gear well (200) and/or configured for mitigating oil frothing within the gear well (200), without limitation.

### FIELD OF THE INVENTION

This disclosure relates generally to the field of crushing and pertains to industrial crushing equipment applicable for use in the mining and aggregate industries.

In particular, disclosed is novel apparatus for facilitating the lubrication of gears in crushers whilst minimizing the probability of oil frothing.

More particularly, an improved helical recess design for a gear well component of a cone crusher is disclosed. The helical recess design aims to reduce stress concentrations in castings, mitigate frothing of oil, and improve the overall robustness and effectiveness of a gear well.

### BACKGROUND OF THE DISCLOSURE

Conventional cone crushers 1 and related crushing devices typically employ an externally-threaded bowl 3, a complementary internally-threaded adjustment ring 9 which surrounds a lower portion of the bowl 3, and a complementary internally-threaded clamping ring 2 located above the adjustment ring 9 which also surrounds the bowl 3.

During normal crushing operation, the clamping ring 2 remains fixed to the adjustment ring 9 and is held static in relation thereto, wherein the external threads of the bowl 3 are secured therebetween and the bowl 3 is therefore also held static in relation to the adjustment ring 9 and clamping ring 2.

To remove a bowl 3 from a crushing device 1 for maintenance, install a bowl 3 into a crushing device 1, or adjust a gap size between a mantle 19 and a cone 20 in situ (which, in turn, sets a material crush size), the bowl 3 is rotated via a peripheral drive motor 13 which turns a ring gear 11 attached to the bowl 3 via a web 10. The bowl 3 is turned whilst the clamping ring 2 and adjustment ring 9 are held in a vertically stationary configuration, thus resulting in simultaneous linear vertical and rotational movement/displacement of the bowl 3. The displacement of the bowl 3 sets a crushing gap distance between the mantle 19 and cone 20, thereby setting the size of a comminuted product.

As shown in FIG. 1, a cone crusher 1 may have a clamping ring 2 connected to an adjustment ring 9 via fastening means 14. The inside diameter portion of the clamping ring 2 and adjustment ring 9 may each comprise female threads which may comprise exaggerated flanks (e.g., buttress threads), without limitation. The threads of each of the components may be similar or identical, and they may compliment an external thread of a bowl 3, without limitation.

The outside diameter portion of the bowl 3 may comprise a male thread (i.e., the bowl 3 may be externally-threaded). The outer thread of the bowl 3 may correspond to the thread provided to each of the adjustment ring 9 and the clamping ring 2 as shown in FIG. 1. The bowl 3 may be provided with a web 10 or other flange-like member which serves as a connection to an outer ring gear 11. Alternatively, a ring gear 11 may be directly connected to the bowl 3.

A drive motor 13 provided with a pinion 12 may cooperatively engage the ring gear 11 to drive/rotate the ring gear 11 and rotate the bowl 3. By virtue of the drive motor 13 turning both the pinion 12 and the ring gear 11, the web 10 and bowl 3 collectively rotate in unison with respect to the crushing device 1, adjustment ring 9, and clamping ring 2. As the bowl 3 rotates, surfaces between the thread of the bowl 3 and the thread of the clamping ring 2 move with respect to each other.

The ring gear 11 may comprise external teeth which mate with complementary teeth on the pinion 12. It is envisaged that other drive mechanisms (e.g., worm gears, helical gears, spur gears, and like arrangements) may be equally employed between the drive motor 13 and bowl 3, without limitation.

To facilitate installation of the bowl 3 to the crushing device 1, removal of the bowl 3 from the crushing device 1, or vertical movement of the bowl 3 relative to the crushing device 1 (i.e., in order to set or adjust a crush size or open/close the crushing gap between a mantle 19 and a cone 20), fastening means 14 connecting the clamping ring 2 to the adjustment ring 9 may be disengaged to allow the drive motor 13 to more easily turn the bowl 3 via the pinion 12 and ring gear 11. To set a fixed crushing gap size for crushing operations, the clamping ring 2 may be secured to the adjustment ring 9 via re-engagement of the fastening means 14.

As shown, fastening means 14 may comprise fasteners which pass through the clamping ring 2 and threadedly engage the adjustment ring 9. By securing the clamping ring 2 to the adjustment ring 9 with the fastening means 14, the bowl 3 can be held against both rotational and vertical movement with respect to the clamping ring 2 and neighboring adjustment ring 9.

Industrial crushers such as cone crushers 1 also traditionally have gear wells 100 comprising a body 106, and a uniform-depth partially-annular recess 110. The partially-annular recess 110 generally comprises a non-helical, partially-annular floor (which may be planar, frusto-conical, or otherwise radially-inwardly tapered as shown). The conventional gear well 100 is generally configured to receive an annular driven gear 15 (e.g., which is typically provided as a miter or bevel gear).

Traditionally, a large cutout 120 extends downwardly from a portion of the partially-annular recess 110 at an abrupt right angle or similar, forming a sharp corner transition 112 between the generally horizontally positioned partially-annular recess floor 111 and the substantially vertical wall 126 of the large cutout 120. The large cutout 120 serves to provide ample clearance space for a drive pinion 18 to be situated and rotate unhindered—the purpose of the drive pinion 18 being to move the driven gear 15. The large cutout 120 is normally configured as a substantially rectangular cavity as shown in FIGS. 2-5.

A drive motor (not shown or labeled) rotates a drive shaft 17 which is provided with the drive pinion gear 18 at its distal end. The drive pinion gear 18 in turn, drives/rotates the driven gear 15 which may be integrally-provided to or attached to an eccentric 4 having a central opening. A shaft 16 may pass through the eccentric 4, driven gear 15, and body 106 of the gear well 100. A central opening 128 in the gear well 100 may be tapered and serve as a thrust bearing for supporting shaft 116 as suggested in FIGS. 1, 4, and 5.

Often, the sharp angle transition 112 between the partially-annular recess 110 and the rectangular cavity 120 can cause a significant rise in stress concentration during operation and can be a common mode of failure of a gear well 100 (e.g., via cracking). Thin wall sections adjacent the sharp angle transition 112 may be present from castings formed by current methods and designs; and, over time, even ductile gear well 100 castings can begin to see evidence of hairline cracks and formation of stress fractures originating near the sharp angle transition 112.

Another problem with this sharp angle transition or corner 112, is that oil lubricating the gearing couple 15, 18 can become turbulent as it flows over the sharp angle transition 112 from the floor 111 of the partially-annular recess 110, past the vertical side wall 126. This “spilling over” or “waterfalling” can lead to undesirable frothing in the power train of the crusher 1.

### OBJECTS OF THE INVENTION

It is, therefore, an object of the invention to circumvent the aforementioned drawbacks associated with prior art gear wells for crushers.

It is a further object of some non-limiting embodiments of the invention to extend the useful and/or serviceable life of a gear well, without limitation.

It is yet a further object of some non-limiting embodiments of the invention to improve the hydrodynamic performance of a gear well and reduce lubricating oil frothing during continuous operation, without limitation.

These and other objects of the invention will be apparent from the drawings and description herein. Although every object of the invention is believed to be attained by at least one embodiment of the invention, there is not necessarily any one embodiment of the invention that achieves all of the objects of the invention.

### BRIEF SUMMARY OF THE INVENTION

Disclosed, is a gear well 200 for a crusher 1. According to some preferred embodiments, the gear well 200 may comprise a body 206, a recess 210, and a pinion clearance floor 222. The recess 210 is preferably configured to be positioned adjacent a driven gear 15 for an eccentric 4. The recess further 210 comprises a floor 211. The gear well 200 may be characterized in that its recess 210 comprises a helical, non-uniform depth recess having a high point 212A and a low point 212B (and a distance along a Z-axis or centerline axis 206 of the gear well 200 separating the high point 212A from the low point 212B). Accordingly, rather than extending to a sharp corner transition 112 and then to an orthogonal sidewall 126 as done with prior art designs, the helical floor 211 of the improved helical recess 210 instead intersects or blends with the pinion clearance floor 222 adjacent the low point 212B (e.g., without vertical sidewall 126 and/or without sharp corner transition 112). The helical, non-uniform depth recess 210 may be configured for improving the strength of a gear well 200 by removing sharp corner transition 112 and the stress rising factors associated with employing a right-angle thin wall in a casting. Alternatively, or in addition to this, the helical recess 210 may be configured to reduce or otherwise mitigate oil frothing within the gear well 200.

According to some embodiments, an angular distance theta (e) representing the angular span of the recess 210 around a centerline axis 206 of the gear well 200 and extending between the low point 212B of the recess 210 and the high point 212A of the recess 210, may be greater than 45 degrees, but less than 335 degrees, without limitation. In other words, the helix/spiral path of the recess 210 is less than one revolution around axis 206.

For example, according to some embodiments, the angular distance theta (e) representing the angular span of the recess 210 around a centerline axis 206 of the gear well 200 and extending between the low point 212B of the recess 210 and the high point 212A of the recess 210, may be greater than 90 degrees, but less than 270 degrees, without limitation.

As another example, in some embodiments, the angular distance theta (e) representing the angular span of the recess 210 around a centerline axis 206 of the gear well 200 and extending between the low point 212B of the recess 210 and the high point 212A of the recess 210, may be greater than 135 degrees, but less than 225 degrees, without limitation.

As yet another example, in some embodiments, and as shown in exemplary and non-limiting FIGS. 6-9, the angular distance theta (e) representing the angular span of the recess 210 around a centerline axis 206 of the gear well 200 and extending between the low point 212B of the recess 210 and the high point 212A of the recess 210 may be approximately 180 degrees, without limitation.

A crusher 1 is also disclosed. The crusher 1 may comprise a cone 20 supported by a shaft 16—the cone 20 forming a first crushing surface. The crusher 1 may further comprise a mantle 19 positioned adjacent the cone 20 the mantle 19 forming a second crushing surface. The shaft 16 may be disposed within an eccentric 4 and supported by a gear well. The eccentric 4 may be operably coupled to a driven gear 15. The driven gear 15 may be situated within or positioned adjacent a recess 210 of the gear well 100.

The gear well 200 may have a body 206; a recess 210 configured to be positioned adjacent the driven gear 15 associated with the eccentric 4; and a pinion clearance floor 222. Moreover, the recess 210 may comprise a floor 211 which may be configured to convey oil.

The crusher 1 may be characterized in that the floor 211 of the recess 210 in the gear well 200 is preferably helical in nature (i.e., in the form of a spiral, coil, helix, or the like) as shown in FIGS. 6-9. In other words, the gear well 200 may be characterized in that it comprises a helical, non-uniform depth recess having a high point 212A and a low point 212B, rather than existing in the same plane along a Z-axis or centerline axis 106 as seen with the prior art design of FIGS. 2-5. A vertical distance along a Z-axis or a distance along centerline axis 206 separates the high point 212A from the low point 2128. Accordingly, rather than extending to a sharp corner transition 112 and then to an orthogonal sidewall 126, the floor 211 of the recess 210 according to present embodiments instead intersects or blends with the pinion clearance floor 222 adjacent the low point 212B.

The helical, non-uniform depth recess 210 may be configured for improving the strength of a gear well 200. Alternatively, or in addition to this, the recess 210 may be configured to reduce or otherwise mitigate oil frothing within the gear well 200.

The above-described gear well 200 having a helical non-uniform depth recess 210 may be installed into a crusher 1 according to some embodiments. Steps may include providing a replacement gear well 200 as described above, and having a body 206, a recess 210 configured to be positioned adjacent a driven gear 15 for an eccentric 4, a pinion clearance floor 222, and a floor 211 provided to the recess 210. Steps may also include removing a gear well 100 having a partially-annular recess 110 from a crusher 1 and installing the replacement gear well 200 into the crusher 1, without limitation.

### BRIEF SUMMARY OF THE DRAWINGS

To complement the description which is being made, and for the purpose of aiding to better understand the features of the invention, a set of drawings illustrating new and novel gear well apparatus for improving crushers is attached to the present specification as an integral part thereof, in which the following has been depicted with an illustrative and non-limiting character. It should be understood that like reference numbers used in the drawings (if any are used) may identify like components.

FIG. 1 illustrates a crusher 1 according to the prior art which may benefit from embodiments of the invention.

FIG. 2 illustrates a partial zoom cutaway view of a traditional gear well 100 found in the crusher 1 shown in FIG. 1.

FIG. 3 shows a side view of the gear well 100 shown in FIGS. 1 and 2.

FIG. 4 shows a side cutaway view of the gear well 100 shown in FIG. 3.

FIG. 5 is an isometric cutaway view of the gear well 100 shown in FIGS. 1-4.

FIG. 6 illustrates a partial zoom cutaway view of a gear well 200 according to some exemplary non-limiting embodiments, which may be used to improve the crusher 1 shown in FIG. 1.

FIG. 7 shows a side view of the gear well 200 shown in FIG. 6.

FIG. 8 shows a side cutaway view of the gear well 200 shown in FIG. 7.

FIG. 9 is an isometric cutaway view of the gear well 200 shown in FIGS. 6-8.

FIG. 10 is a schematic diagram showing a possible exemplary range of angular span for a helical recess 210 according to some non-limiting embodiments.

FIG. 11 suggests a method for installing a gear well 200 according to some embodiments.

In the following, the invention will be described in more detail with reference to drawings in conjunction with exemplary embodiments.

### DETAILED DESCRIPTION

While the present invention has been described herein using exemplary embodiments of a gear well 200 for a crusher 1 and a method of installing the same, it should be understood that numerous variations and adaptations will be apparent to those of ordinary skill in the field from the teachings provided herein.

The detailed embodiments shown and described in the text and figures should not be construed as limiting in scope; rather, all provided embodiments should be considered to be exemplary in nature. Accordingly, this invention is only limited by the appended claims.

The disclosure of every patent, patent application, and publication cited, listed, named, or mentioned herein is hereby incorporated by reference in its entirety, for any and all purposes, as if fully set forth herein.

While this subject matter has been disclosed with reference to specific embodiments, it is apparent that other embodiments and variations can be devised by others skilled in the art without departing from the true spirit and scope of the subject matter described herein. The appended claims may include some, but not all of such embodiments and equivalent variations.

The described embodiments are to be considered in all respects only as illustrative and not restrictive. The scope of the invention is, therefore, indicated and governed only by the appended claims, rather than by the foregoing description. All embodiments which come within the meaning and range of equivalency of the claims are to be embraced within their scope.

The inventors have recognized a novel and heretofore unappreciated design for a gear well 200 of crushing devices 1—in particular, those used in cone crusher drive trains, without limitation.

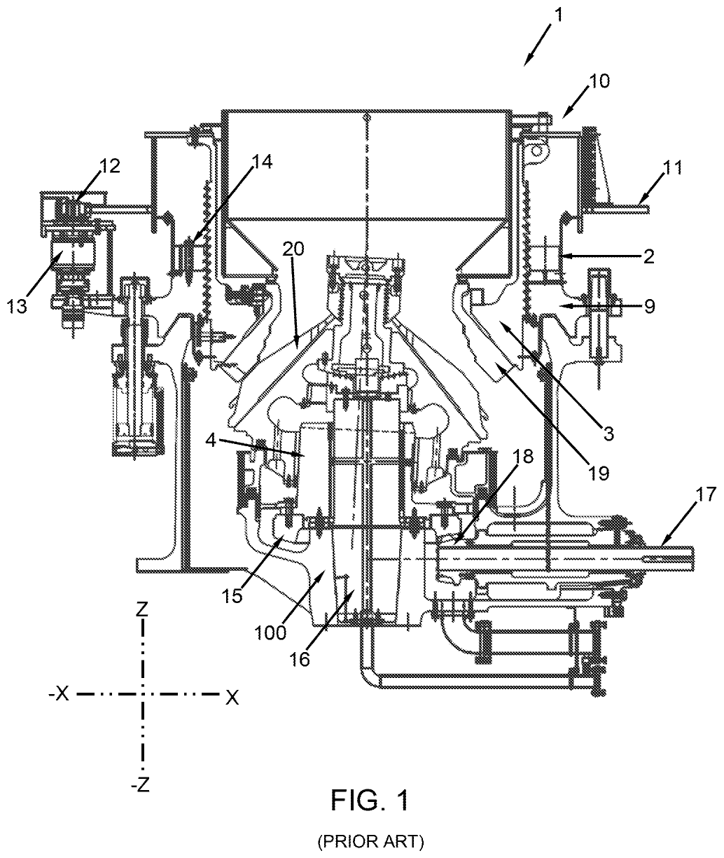

Turning now to prior art FIG. 1, a crusher 1 (e.g., a cone crusher) may comprise an internally-threaded clamping ring 2 and an externally-threaded bowl 3 threadedly-engaging the clamping ring 2. The bowl 3 may operatively engage a mantle 19 which forms an upper crushing surface. An internally-threaded adjustment ring 9 also threadedly-engages the bowl 3. A web 10 may extend from the bowl 3 and connect the bowl 3 to an outer ring gear 11. The outer ring gear 11 may communicate with a pinion 12 driven by a peripheral drive motor 13.

Upon powering the peripheral drive motor 13, the pinion 12 rotates and thus turns the outer ring gear 11, web 10, and connected bowl 3. Upon rotational movement of the bowl 3, a crushing gap (i.e., distance between the mantle 19 and cone 20) may be adjusted, thereby changing the size of comminuted product produced.

Fastening means 14 may be provided between the adjustment ring 9 and the clamping ring 2 to prevent relative movement between parts 2, 9, 3 of the crusher 1 during operation. The fastening means 14 may be loosened or removed to allow removal or adjustment of the parts 2, 9, 3 of the crusher 1.

On a lower internal section of the crusher 1, a cone 20 forming a lower crushing surface is supported by a shaft 16 guided by an eccentric 4 which surrounds the shaft 16. The eccentric 4 is coupled to a driven gear 15 (e.g., at a lower portion of the eccentric 4). Driven gear 15 may alternatively be formed monolithically with the eccentric 4. A drive shaft 17 configured to be coupled to a drive motor/transmission output (not shown), powers the crusher 1 by rotating a drive pinion 18 thereon. The drive pinion 18 makes contact with the driven gear 15. The driven gear 15 and drive pinion 18 are typically of the miter or bevel gear type, without limitation.

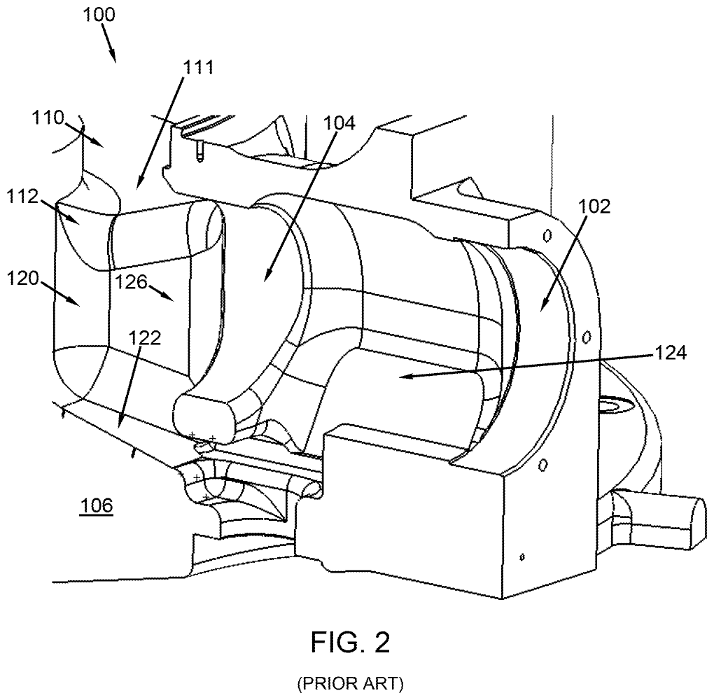

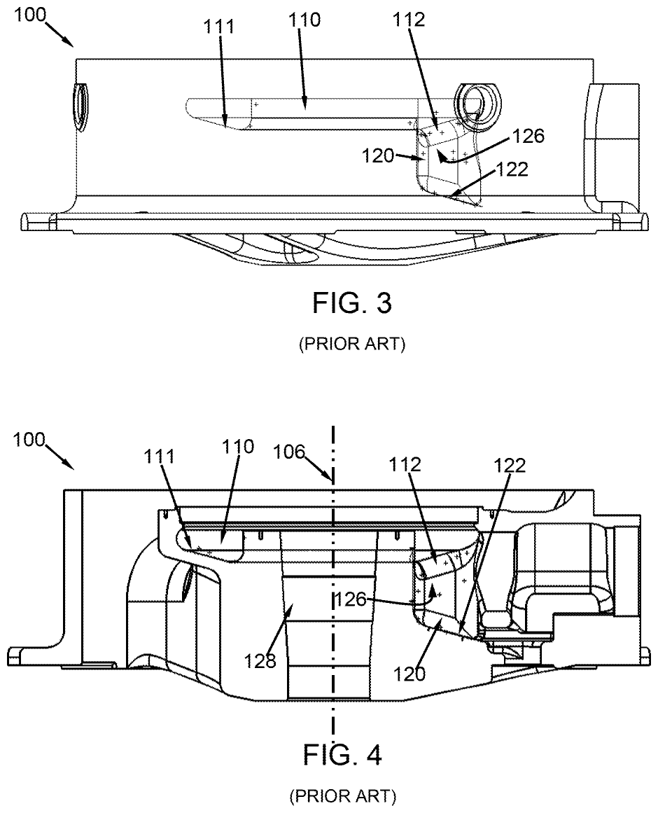

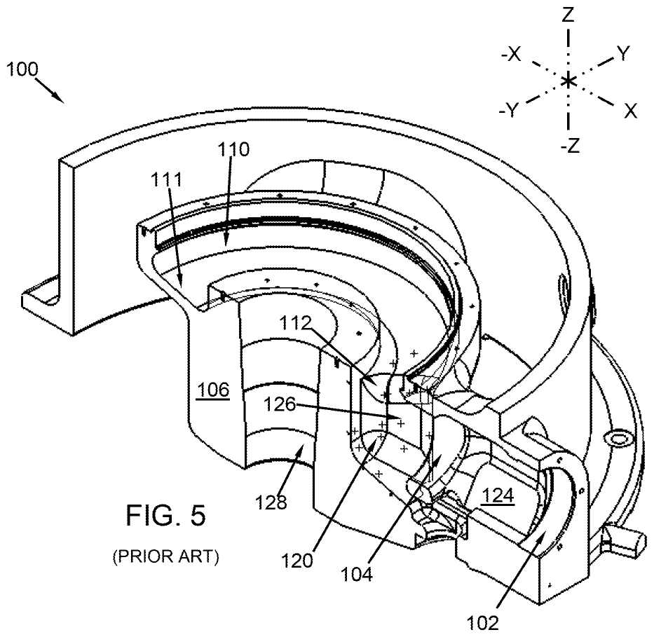

A conventional gear well 100 (e.g., the one shown in FIGS. 2-5) may be placed below the eccentric 4 and may support the eccentric 4 and/or serve as a lower support bearing (e.g., a thrust bearing) for shaft 16, without limitation. A bearing may allow relative rotational movement between eccentric 4 and conventional gear well 100. The conventional gear well 100 comprises first drive shaft bearing 102 (e.g., sleeve, journal, or race), a second drive shaft bearing 103 (e.g., sleeve, journal, or race), and an opening 124 therebetween, in order to support drive shaft 17 and provide lubrication or reduce friction between portions of the conventional gear well 100 and the drive shaft 17.

The body 106 of the conventional gear well 100 is provided with a non-helical, uniform-depth, partially-annular recess 110 which has a partially-annular recess floor 111. Points along the partially-annular recess floor 111, may be defined as a series of polar coordinates that share a similar radius and also substantially fall within the same horizontally-oriented plane along a height axis of the crusher or centerline axis 106 of the conventional gear well 100. In other words, points along the partially-annular recess floor 111 may share a similar elevation or “Z-axis” position within crusher 1, if they share a similar radial location. In other words, with prior gear wells 100, two separate points on the floor 111 of the recess 110 which are equidistant from centerline axis 106 would also share a common position along centerline axis 106, without limitation.

A junction/interruption in the non-helical, uniform depth partially-annular recess 110 exists, where there is a conventional sharp corner transition 112 to a substantially vertical sidewall 126 forming a portion of a large cutout 120. The large cutout 120 further comprises a floor 122 which provides a clearance for drive pinion 18. The large cutout 120 may at least partially serve as a basin for lubricating oil intended for drive pinion 18 and driven gear 15. The sidewall 126 and floor 111 are generally perpendicular/orthogonal to each other and joined by the sharp corner transition 112 at their intersection as shown in the drawings.

A problem with the prior art gear well 100 design shown in FIGS. 1-5 is that high stresses within the gear well 100 may cause cracking along or adjacent the conventional sharp corner transition 112, which tends to comprise a thin wall of cast iron.

Another problem with the prior art gear well 100 design shown in FIGS. 1-5 is that oil contained on surfaces of the driven gear 15 drip down into the top surfaces of partially-annular recess 110 and due to a small clearance therebetween, the oil may be churned by teeth of the driven gear 15 as the driven gear 15 rotates. Moreover, the churned oil may further froth due to high turbulence as it cascades over the sharp corner transition 112 and splashes into the catch basin formed by large cutout 120, sidewall 126, and pinion clearance floor 122.

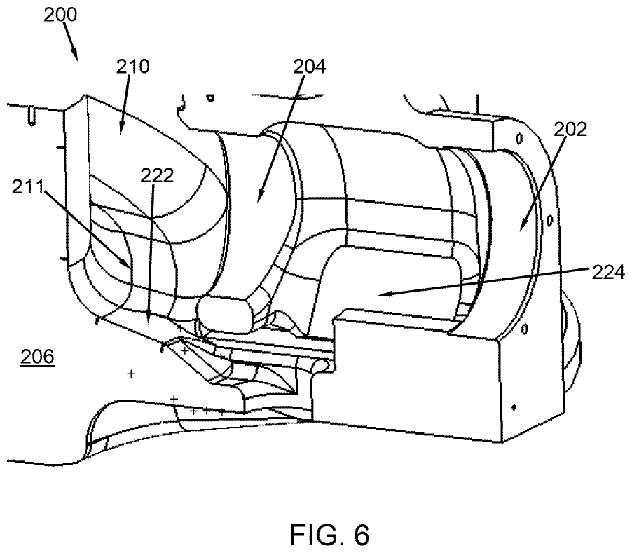

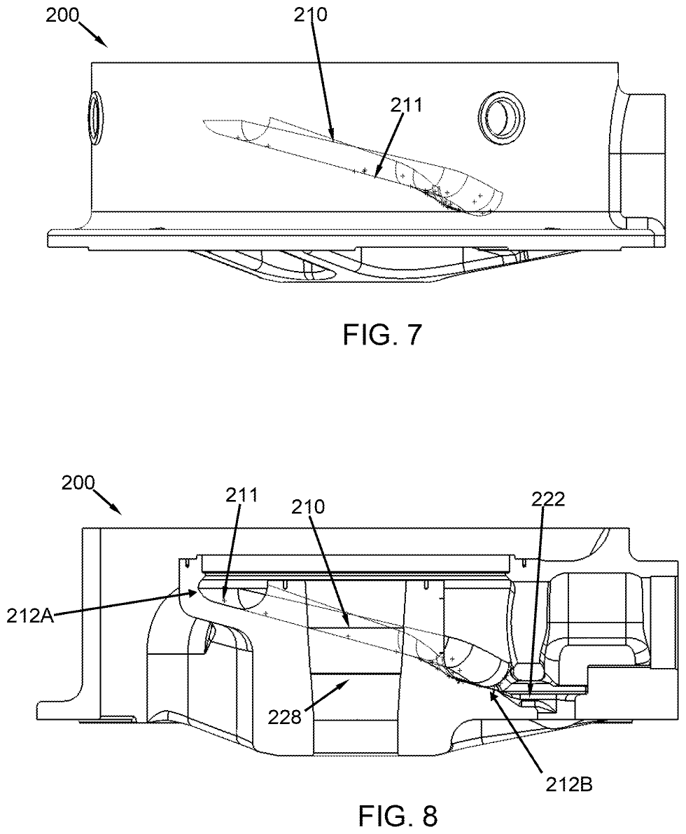

Turning now to FIGS. 6-9, an improved gear well 200 according to some embodiments may similarly comprise a first drive shaft bearing 202 (e.g., sleeve, journal, or race) and a second drive shaft bearing 204 (e.g., sleeve, journal, or race) which are configured to support drive shaft 17 and a drive pinion 18 thereon. An opening 224 may extend therebetween.

A driven gear 15 (to which the pinion 18 engages to rotate the eccentric 4) is configured to spin freely within a helical recess 210 of substantially non-uniform depth. As shown, the helical recess 210 may comprise a helical recess floor 211 which blends with a pinion clearance floor 222 located under and providing clearance for drive pinion 18. The helical recess floor 211 extends from a high point 212A (e.g., at the start of the helical recess 210) to a low point 212B (e.g., at the end of the helical recess 210) as shown. The helical recess 210 removes the sharp corner transition 112 and large vertical wall 126, and instead blends recess 210 into the large cutout area configured to receive pinion 18.

By virtue of the sloped floor 211, oil lubricating the drive pinion 18 and driven gear 15 can slide down, via gravity, with little turbulence, and re-lubricate the drive pinion 18. The oil may pool adjacent the pinion within a basin area formed by pinion clearance floor 222. Oil received by surfaces of the drive pinion 18 while the pinion 18 is rotating may be subsequently brought into contact with the driven gear 15, thereby lubricating the gearing couple and tooth surfaces therebetween. The floor 211 of the helical recess 210 may thereby be configured to reduce frothing of lubricating oil, since the gear well 200 substitutes prior art features 110, 111, 112, 126 which allow oil to splash around inside the crusher 1 (e.g., spill over a conventional sharp corner transition 112 between a conventional partially-annular recess floor 111 and a sidewall 126 of a conventional large cutout 120).

Moreover, due to the helical design, overall strength of the gear well 200 may be increased, and the clearance between pooled oil and rotating teeth of the driven gear 15 may be increased due to the gradual increase in separation between high point 212A and low point 212B as the recess 210 traverses around centerline axis 206.

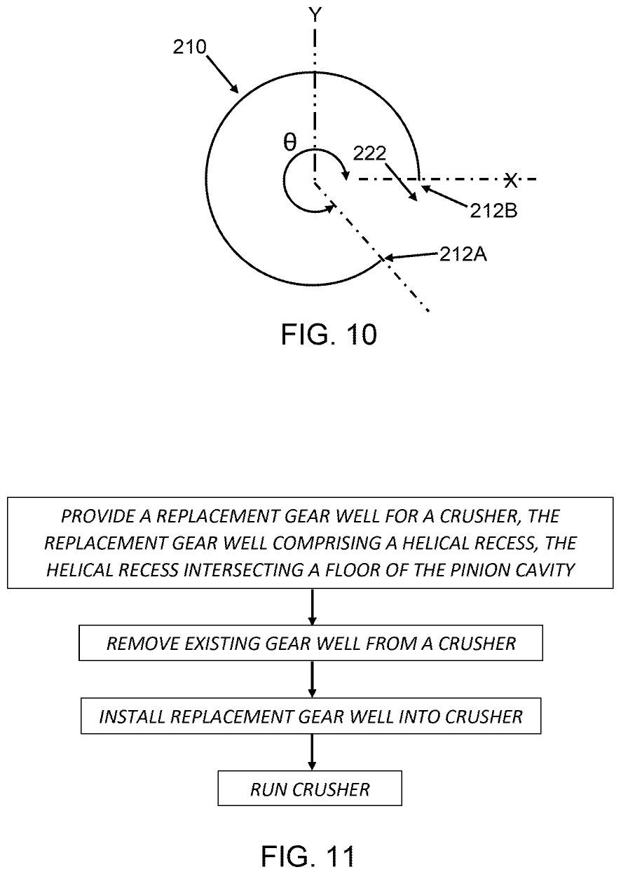

Turning now to FIG. 10, it will be appreciated that a helical, non-uniform depth recess 210 described herein may start at a high point 212A, and extend to a low point 212B as it traverses around a gear well 200, without limitation. The shortest angular distance between the high point 212A and low point 212B may be set to just slightly more or greater than the width of the drive pinion 18, so as to configure cutout 220 to provide enough clearance for drive pinion 18 to turn, whilst maximizing the circumferential length/span of the helical recess 210. By making helical recess 210 longer, its slope can be made more gradual. By making helical recess 210 shorter, its slope can be made steeper. It should be understood that the rise over run (e.g., relative slope, grade, steepness) of the floor 211 of the helical recess 210 may be constant as shown, or it may vary at different angular locations around axis 206. Accordingly, embodiments of a gear well 200 wherein recesses 210 comprise “compound” or “variable pitch” helix geometries are completely within the scope of this disclosure.

An angular distance theta (e) may represent the angular span of a helical recess 210 for a gear well 200 according to certain embodiments of the invention. This theta θ angle may be conceptualized as the circular distance the helical recess 210 spans or travels circumferentially, around the centerline axis 206 of the gear well 200 in its spiral/helical path. Theta θ angle may alternatively be conceptualized as the circular distance the helical recess 210 spans or travels circumferentially, around the Z-Axis or centerline axis 206. Theta θ angle may, as shown, be represented in degrees with respect to polar coordinates for purposes of this disclosure, without limitation; wherein zero degrees may be representative of the location of intersection between the helical recess floor 211 and the pinion clearance floor 222.

Most-preferred envisaged embodiments within the scope of this disclosure may have a theta θ angle (e.g., an absolute theta θ angle) which is greater than approximately 90 degrees, but less than approximately 270 degrees, for example, 180 degrees as shown, without limitation.

In the non-limiting embodiment shown in FIGS. 6-9, the helical recess 210 is shown to extend 180 degrees around the gear well 200, wherein theta θ may be approximated as 180 degrees. This is because the high point 212A of the helical recess floor 211 is positioned at a polar angular coordinate comprising 180 degrees and the low point 212B of the helical recess floor 211 is positioned at a polar angular coordinate comprising zero degrees, and therefore, the two points 212A, 212B are polar opposites.

It should be noted that the two points 212A, 212B do not share the same location along a central centerline axis 206 of the gear well, and therefore, also have different vertical locations within a crusher 1 along a Z-axis. Accordingly, the helical recess 210 disclosed encourages oil to flow less-turbulently downward along the floor 211 surface, via gravity, and into the large cavity sump area defined by pinion clearance floor 222. In this regard, pinion 18 can remain well-lubricated without the negative effects of oil frothing common with traditional gear wells 100.

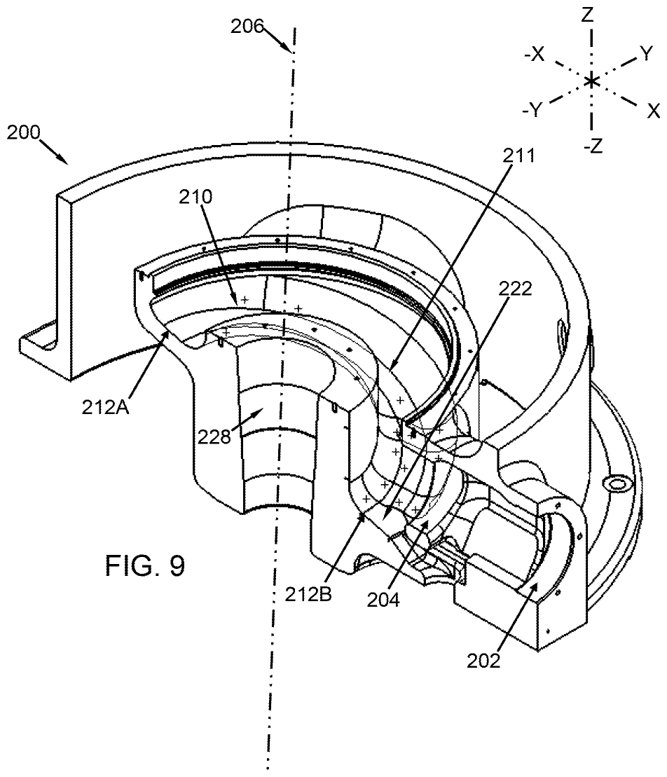

FIG. 9 suggests that theta θ may exceed 180 degrees in some preferred embodiments (e.g., approximately 335 degrees) or be less than 180 degrees; however envisaged embodiments within the scope of this disclosure comprise theta θ angles which do not approach 360 degrees. Preferred embodiments of a gear well 200 may comprise a theta θ angle which is at least 90 degrees, but no more than 270 degrees. For example, a theta θ angle too small may result in too steep of a helical recess 210, thereby reducing the effectiveness of oil froth mitigation.

In some embodiments, a method of installing a gear well 200 may be performed. In some embodiments, the method may involve assembling parts of a crusher 1 with a gear well 200 described herein, to form an improved crusher 1 comprising a gear well 200 having a helical recess 210.

Turning now to FIG. 11, in some embodiments, a method of retrofitting a crusher 1 with a gear well 200 according to embodiments of the invention described herein may be performed. As suggested in the figure, the method may involve removing an old gear well 100 having a non-helical uniform depth partially-annular recess 110 from a crusher 1 (e.g., a gear well 100 as shown and described in prior art FIGS. 2-5), and then replacing it with a gear well 200 described herein (e.g., a gear well 200 as shown and described in FIGS. 6-9), to form an improved crusher 1 comprising a gear well 200 having a helical recess 210.

A contractor or other entity may provide a gear well 200 as substantially described herein, or may practice any one of the methods or method steps described herein, without limitation. Moreover, a contractor or other entity may provide portions or components of a gear well 200 as substantially described herein, or may practice one or more of the method steps described herein, without limitation. A contractor may modify retrofit an existing gear well 100 by welding, machining, adding material, melt-casting, or using other fabrication techniques in order to arrive at a gear well 200 according to present embodiments.

A contractor or other entity may provide a crushing device 1, such as a cone crusher which contains a gear well 200 according to embodiments described herein. Or, a contractor or other entity—such as a client, customer, or user of a crusher 1, may operate the same in whole, or in part. A contractor or other entity may install a gear well 200 according to embodiments described herein, into a crusher 1, without limitation.

A contractor or other entity may receive a bid request for a project related to designing, fabricating, delivering, installing, operating, or performing maintenance on a gear well 200 disclosed herein, without limitation. A contractor or other entity may offer to design a similar system, device, or apparatus, or provide a process or service pertaining thereto, for a client. A contractor or other entity may offer to retrofit or may actually retrofit an existing gear well 100 with any one or more of the components or physical features described herein (e.g., helical recess 210, sloped floor 211, high 212A and low 212B points, or the like, without limitation), to make an improved gear well 200 for a crusher 1 or to improve or refurbish a crusher 1. It is further anticipated that a contractor or other entity may, in accordance with the inventive concepts and teachings described herein, offer for sale, sell to, deliver to, and/or install one or more of the gear wells 200 described herein for an end user, client, or customer, without limitation.

Although the invention has been described in terms of particular embodiments and applications, it should be appreciated that one of ordinary skill in the art, in light of this teaching, can generate additional embodiments and modifications without departing from the spirit of or exceeding the scope of the claimed invention.

### REFERENCE NUMERAL IDENTIFIERS

1. Crusher
2. Internally-threaded clamping ring
3. Externally-threaded bowl
4. Eccentric
9. Internally-threaded adjustment ring
10. Web
11. Outer ring gear
12. Pinion
13. Peripheral drive motor
14. Fastening means
15. Driven gear
16. Shaft
17. Drive shaft
18. Drive pinion
19. Mantle
20. Cone
100. Gear well (conventional)
102. First drive shaft bearing (e.g., sleeve, journal, or race)
103. Second drive shaft bearing (e.g., sleeve, journal, or race)
106. Body (conventional)
108. Centerline axis (conventional)
110. Non-helical partially-annular recess (conventional, e.g., of “uniform depth”)
111. Non-helical, uniform depth partially-annular recess floor (conventional)
112. Sharp corner transition (conventional)
120. Large cutout (conventional)
122. Pinion clearance floor (conventional)
124. Opening
126. Sidewall of large cutout (conventional)
128. Tapered opening/thrust bearing (conventional)
200. Gear well
202. First drive shaft bearing (e.g., sleeve, journal, or race)
204. Second drive shaft bearing (e.g., sleeve, journal, or race)
206. Centerline axis
210. Helical recess (i.e., of “non-uniform” depth)
211. Helical recess floor
212A. High point (e.g., start of Helical, non-uniform depth recess)
212B. Low point (e.g., end of Helical, non-uniform depth recess)
222. Pinion clearance floor
224. Opening
228. Tapered opening/thrust bearing

1. (canceled)

2. A gear well for a crusher comprising:
a body;
a recess configured to be positioned adjacent a driven gear for an eccentric, wherein the recess comprises a floor; and
a pinion clearance floor;
the recess comprises a helical, non-uniform depth recess having a high point and a low point; and,
rather than extending to a sharp corner transition and then to an orthogonal sidewall, the floor of the recess instead intersects or blends with the pinion clearance floor adjacent the low point;
wherein the helical, non-uniform depth recess is configured for improving the strength of a gear well or mitigating oil frothing within the gear well.

3. The gear well for a crusher according to claim 2, wherein an angular distance theta (θ) representing the angular span of the recess around a centerline axis of the gear well and extending between the low point of the recess and the high point of the recess, is greater than 45 degrees, but less than 335 degrees.

4. The gear well for a crusher according to claim 2 or 3, wherein the angular distance theta (θ) representing the angular span of the recess around a centerline axis of the gear well and extending between the low point of the recess and the high point of the recess, is greater than 90 degrees, but less than 270 degrees.

5. The gear well for a crusher according to any one of claims 2-4, wherein the angular distance theta (θ) representing the angular span of the recess around a centerline axis of the gear well and extending between the low point of the recess and the high point of the recess, is greater than 135 degrees, but less than 225 degrees.

6. The gear well for a crusher according to any one of claims 2-5, wherein the angular distance theta (θ) representing the angular span of the recess around a centerline axis of the gear well and extending between the low point of the recess and the high point of the recess, is 180 degrees.

7. A crusher comprising:
a cone supported by a shaft and forming a first crushing surface;
a mantle positioned adjacent the cone and forming a second crushing surface;
the shaft being disposed within an eccentric operably coupled to a driven gear and within a gear well;
the gear well having a body; a recess configured to be positioned adjacent a driven gear for an eccentric; and a pinion clearance floor; wherein the recess comprises a floor;
the crusher comprises the gear well according to any one of preceding claims 2-6.

8. A method of installing a gear well into a crusher comprising:
removing a gear well having a partially-annular recess from the crusher;
providing a replacement gear well having a body; a recess configured to be positioned adjacent a driven gear for an eccentric; and a pinion clearance floor; wherein the recess comprises a floor; and
installing the replacement gear well into the crusher;
the replacement gear well comprises the gear well defined in any one of preceding claims 2-6.
